(19) United States
(12) Patent Application Publication
(10) Pub. No.: US 2008/0320054 A1
(43) Pub. Date: Dec. 25, 2008

(54) Database and Software Conversion System and Method

(76) Inventors: Cindy Howard, Parker, TX (US); Thomas Howard, Parker, TX (US); James Carpenter, Plano, TX (US)

Correspondence Address: ANDREWS & KURTH, L.L.P., 600 TRAVIS, SUITE 4200, HOUSTON, TX, 77002, US

(21) Appl. No.: 12/204,753

(22) Filed: Sep. 4, 2008

Related U.S. Application Data
(63) Continuation of application No. 10/821,085, filed on Apr. 8, 2004.
(60) Provisional application No. 60/461,509, filed on Apr. 9, 2003.

(51) Int. Cl. G06F 17/30

(52) U.S. Cl. 707/201; 707/E17.045

(57) ABSTRACT

An apparatus and method for converting databases and software source code from one or more languages or formats to one or more differing target languages or formats by a process of identifying within the original software various functions, storing in a common database format the varying functions resolved into their most basic elements, and based on the stored elements and their interrelationships, writing new target software using one or more templates which incorporate the business logic of the original software by integrating the stored elements and interrelationships. The templates incorporate a unique algorithmic template language which is understood by the constructor and which is easily modified by the user. The language includes, variables, functions and advanced controls such as conditional processing and looping.

### CROSS REFERENCE TO RELATED APPLICATIONS

This application is a continuation of U.S. patent application Ser. No. 10/821,085 filed on Apr. 8, 2004, which is based upon provisional application No. 60/461,509 filed on Apr. 9, 2003, the priority of which is claimed.

### BACKGROUND OF THE INVENTION

1. Field of the Invention

This invention relates generally to computerized database application systems and specifically to a method and system for automatically converting database application systems, and particularly to a method and system for automatically converting a non-relational database application system to a relational database application system using a common construct software database.

2. Description of the Prior Art

In today's rapidly changing commercial and social environment, many companies demand a reliable database engine that easily adapts to emerging global and technology trends, allowing the reuse and synergy of their existing information technology (IT) assets and removing inhibitors on scalability, database design, data management and data access across legacy and new technology platforms. Today, most organizations are implementing relational databases, which represent data in the form of tables.

The relational data model was introduced in 1970 by E. F. Codd of International Business Machines IBM, and it has continued to evolve. Relational databases are organized around a mathematical theory that aims to maximize flexibility. The relational data model consists of three components: A data structure wherein data are organized in the form of tables; means of data manipulation for manipulating data stored in the tables, e.g. the Structured Query Language SQL; and means for ensuring data integrity in conformance with business rules.

Many relational database systems exist, such as Oracle, MySQL and DB2 from IBM. Relational database systems offer superior scalability and architectural flexibility to provide robust database solutions that perform, adapt and respond to today's business initiatives. Most modern database software is full-featured, robust, scalable and easy to use.

However, the decision to develop new applications using a relational database system is complicated for organizations which have existing legacy database applications, i.e. legacy systems are generally non-relational and have roots stretching back long before relational databases and SQL became corporate standards.

Many organizations have extensive legacy databases developed under IBM's IMS or Computer Associates' IDMS. IMS is a hierarchical database, and IDMS uses the network database model. Unlike relational databases which are designed for flexibility, IMS and IDMS put a premium on performance over flexibility. For example, IMS's hierarchical approach puts every item of data in an inverted-tree structure, extending downward in a series of parent-child relationships. This approach provides a high-performance path to a given datum. The IDMS network database model allows for more complex, overlapping hierarchies, but falls short of the flexibility of a true relational database system. However, IDMS can mimic a relational database relying on functionality from an add-on product.

For an organization running a legacy database system, the advantages of writing new applications using a relational data model are offset by additional costs of running both the relational database and legacy database together. New applications may be constrained by the abilities of the old legacy system which do not integrate well with today's applications and data tools, and licensing fees must be paid for two systems. The organization must have personnel qualified to maintain both systems.

Organizations running legacy systems are confronted with additional issues. Licensing fees for many legacy applications are rising rapidly, and most legacy databases offer only limited scope for continued systems evolution. Users express doubts about how much energy providers of legacy database systems will invest in continuing to modernize and support the technology. The fear is that an eroding customer base will cause the company to further scale back and the technology to become obsolete. Also, most IT personnel are increasingly skilled in relational databases rather than legacy systems, so it is becoming difficult to find experienced legacy programmers and developers.

Reducing the number of database management systems within the IT infrastructure reduces the cost of developing new applications and maintaining existing applications. Licensing fees are reduced, which can be a significant annualized savings.

However, the decision to convert legacy database applications to modern relational database applications is not lightly made. There are strong reasons to avoid migration to a relational database, or to at least postpone it. It takes time and manpower to convert. For example, many legacy systems involve scores of schemas, countless subschemas, numerous computing systems, thousands of programs in differing programming languages, and millions of records. These legacy systems may employ batch mode, legacy online update, and query programs with access using terminal emulation and web screen scraping. In a migration, all of the myriad facets of a legacy system need to be examined for reengineering or conversion, which is no small task.

Additionally, the legacy databases are battle-hardened survivors whose dependability and performance have been refined from 25 to 30 years of use. The legacy technologies have been subjected to years of optimization according to different principles than those that govern relational technologies—work that tends to be lost in a migration. The migration also requires trade-offs of requiring greater computing power and yielding generally slower performance.

Once an organization has decided to migrate a legacy database system to a relational database system, it must then determine whether to rewrite/reengineer the software, convert it, or a combination of the two.

Reengineering and rewriting the application result in a more native mode implementation of the system in the relational environment and can be used to increase the functionality of the system. However, reengineering, rewriting and debugging can be quite costly and take a long time, requiring the organization to maintain the legacy system for a long time after the decision to migrate is made. Reengineered applications usually have a different “look and feel” and require extensive user retraining. If the legacy applications fully meet the business requirements, there may be no compelling reason to rewrite or reengineer them. The time, costs, and risks associated with a rewrite, especially for large applications, may be too great to offset the additional benefits that might be realized.

Converting the legacy system is accomplished with a variety of software tools and has the advantage of establishing a common administrative environment without reinventing the business logic of the existing system. Converted applications have a similar “look and feel” to the legacy software and require little user retraining. Converting generally requires less cost and time to migrate the system than does reengineering. While conversion does not directly increase the functionality of the system, because the legacy system is migrated to a modern relational system, the application is better positioned for future enhancements, particularly for web-enablement. Once converted, the database applications can be developed further as business requirements evolve and change. For existing applications which are both robust and functionally rich, it is both logical and cost-effective to save their inherent value and convert them instead of reengineer/rewrite them.

Myriad software toolsets exist on the market to simplify conversion of a legacy database application to relational database application. Most are developed to migrate a particular legacy database system to a particular relational database system or to convert software code written in a first particular language to code for a second particular language. Further, tools often are limited to a one-to-one translation of the code. A flexible toolset which allows migration to any software language is advantageous.

Identification of Objects of the Invention

A primary object of the invention is to provide a system and method for converting database applications and other original computer software from one or more languages or formats to one or more differing target languages or formats by a process of identifying within the original software various functions, storing in a common database format the varying functions broken down into the most basic elements, and based on the stored elements and their interrelationships, writing new target software using one or more templates which incorporate the business logic of the original software by integrating the stored elements and interrelationships.

Another primary object of the invention is to provide a system and method for writing computer software in any language using templates which include a common and robust template scripting language. The user needs only to know the template language and the basic architecture of the target language to write complex software in any other language.

Another object of the invention is to provide a system and method for migrating computer software and data from one system to another system which allows the user to simply re-engineer or modify the target by changing a conversion template written in a common template language.

### SUMMARY OF THE INVENTION

The objects identified above, as well as other features and advantages of the invention are incorporated in an apparatus and method for converting databases and software source code from one or more languages or formats to one or more differing target languages or formats by a process of identifying within the original software various functions, storing in a common database format the varying functions broken down into their most basic elements, and based on the stored elements and their interrelationships, writing new target software using one or more templates which incorporate the business logic of the original software by integrating the stored elements and interrelationships.

By an iterative sequence of parsing and interrogating collected source software, the system and method of the invention identifies the varying original software components, determines the language(s) of the components, and breaks the components down into base functions, elements, variables, and interrelationships thereof. These basic elements are stored in a common construct database. Within the tables of the common construct database, all relationships and structures within the original software are preserved, thus preserving the business logic of the original software.

Target software is then written by a constructor which uses one or more templates which define the structure of all programs, control blocks, subroutines, etc. The templates incorporate a unique template language which is understood by the constructor and which is easily modified by the user. The language includes variables, functions and advanced controls such as conditional processing and looping. Using the template as a guide, the business logic of the original software, inherent in the stored resolved constituent elements and interrelationships, is integrated in to the new target software. The algorithmic template language allows the user to easily re-engineer the software during the conversion process so that the conversion is not limited to a 1:1 translation of code.

### BRIEF DESCRIPTION OF THE DRAWINGS

The invention is described in detail hereinafter on the basis of the embodiments represented in the accompanying figures, in which:

FIG. 1 illustrates a simplified overall schematic of the system and method according to the invention, showing the basic flow path from the original software environment through the deconstruction module into a common construct database and from the common construct database through the construction module to the target software environment;

FIG. 2 illustrates a detailed schematic of FIG. 1 according to the invention;

FIG. 3 shows a portion of a typical original source file of a legacy database application, specifically the area listing and record description listing of an IDMS schema report;

FIG. 4 shows a portion of a typical original source file of a legacy database application, specifically the set description listing of an IDMS schema report;

FIG. 5 shows typical tables within the common construct database according to the invention populated with data resolved into basic constituent elements from the original source files of FIGS. 3 and 4;

FIG. 6 shows typical tables within the common construct database according to the invention populated with data resolved into basic constituent elements from the original source files of FIGS. 3 and 4;

FIG. 7 shows typical tables within the common construct database according to the invention populated with data resolved into basic constituent elements from the original source files of FIGS. 3 and 4;

FIG. 8 illustrates a portion of a typical source code template written to generate COBOL source code and structured for DB2, showing template variables and language structures written in a template language according to the invention;

FIG. 9 illustrates a subroutine, called within the template of FIG. 8, written in template language according to the invention;

FIG. 10 illustrates a portion of target software code generated by the constructor according to the template of FIG. 8 and incorporating the data of contained in FIGS. 5-7;

FIG. 11 illustrates a portion of target software code generated by the constructor according to the template of FIG. 8 and incorporating the data of contained in FIGS. 5-7; and

FIG. 12 illustrates a portion of a typical English language template written to produce source code documentation.

### DESCRIPTION OF THE PREFERRED EMBODIMENT OF THE INVENTION

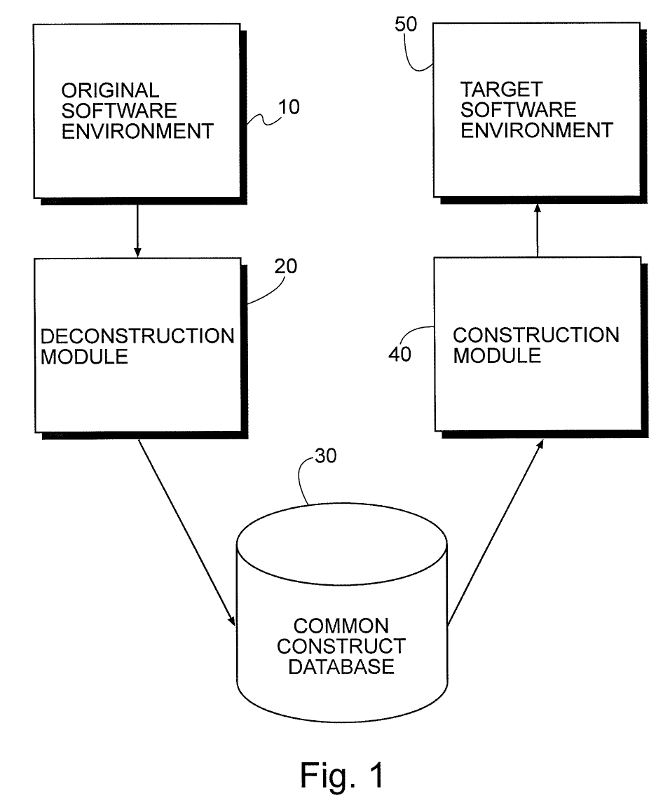

An overview of a preferred embodiment of the method and system according to the invention is shown in FIG. 1. The original software to be converted exists in an original software environment 10 and may consist of various entity types. The original software is processed by a deconstruction software module 20 which breaks the original software down into its most basic constituents. The base constituents are stored in a common construct database 30. A construction software module 40 processes the base constituents to generate target software. The target software is stored in a target software environment 50 and may consist of various entity types.

The original software environment 10, the target software environment 50, the common construct database 30, the deconstruction module 20, and the construction module 40 are contained in at least one computer system. The computer system, well known in the art, has a central processing unit, memory, and input/output devices for interfacing with a user, and is capable of executing software code to access, manipulate and store data. Although not necessary, because the original software environment 10 may be a legacy system and the target environment is generally a more modem system, the original and target software environments may likely exist in two separate computer systems. In all cases, it is recommended that the deconstruction software 20, common construct database 30, and the construction software 40 exist in a conversion processing environment which is separate from the original and target software environments.

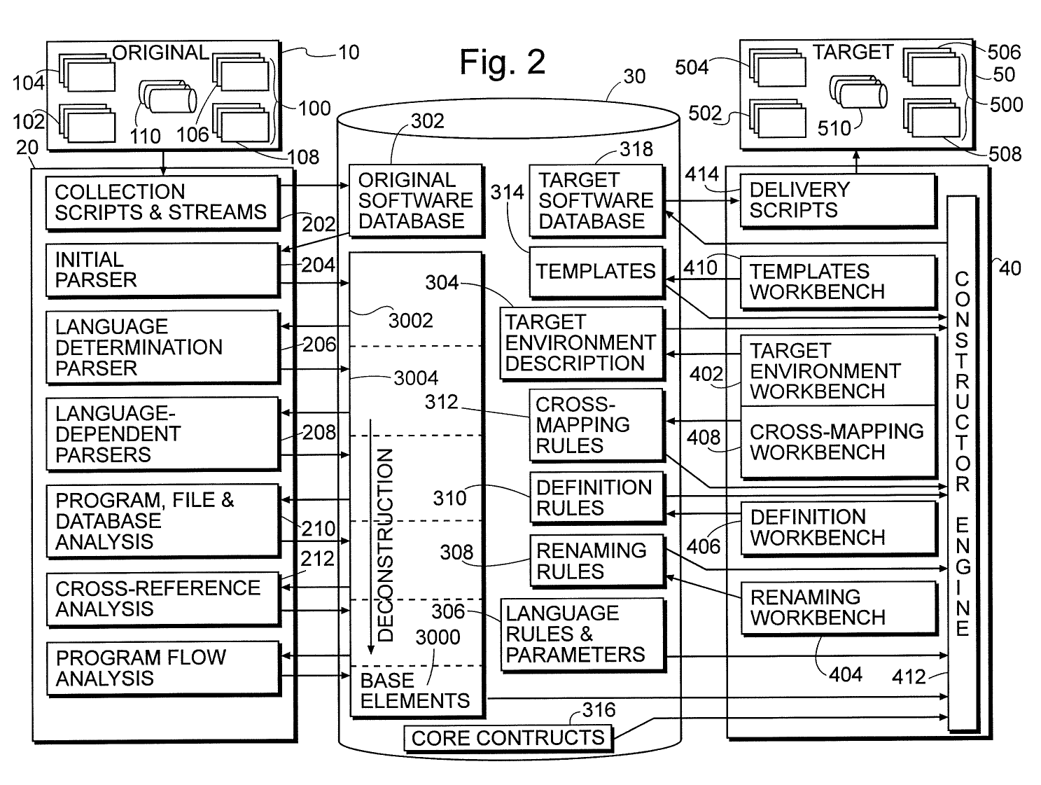

Referring to FIG. 2, the original software 100 to be converted exists in an environment 10 which may contain reports 102, utilities 104, descriptions 106, repository extracts 108 and programs 110, among other software entity types. Software reports 102 generally list and define the software components and parameters within the original software environment 10. Utilities 104 include executables, scripts, control files, or other descriptors which are used within the original software environment 10 to set environmental parameters, to compile programs, and to generate executable software. Descriptors 106 are reports, text documents, control files and other data that further define and document the original software environment 10. Repository extracts 108 are selected and unloaded components including shared copybooks, shared utility streams, special subroutines, etc. which are loaded directly for processing at compilation or execution time. Software programs 110 are source code files which contain the business logic of the software 100. The software 100 may exist in a number of varying formats or languages.

Through a series of job streams, scripts and other collection mechanisms 202 which are based on descriptions of the original environment 10, the original software 100 is collected. The collected source information, in any format, is stored in the Original Software Database 302, a subset of the common construct database 30. Information on the original environment, the original processing mechanism, and the original configuration are all stored in a common database structure in the common construct database 30.

After collection, the original software 100 is deconstructed into its most basic elements or constituents 3000 through a process of parsing and interrogation. First, the contents of the original software database 302, which reflects the original software 100, is passed through a initial parser 204 that reads and isolates each type of original software database component. Original software reports 102, utilities 104, descriptions 106, extracts 108 and programs 110 are resolved into individual program routines, record layouts, objects and other components. The output components 3002 of the initial parsing are placed into a common construct database 30 for further processing. The components are then further broken down into more basic constructs through an iterative process of interrogation and parsing, until all software components have been broken down to their most basic elements or constituents 3000.

The process includes a language determination parser 206 which uses a simple set of pre-defined rules and filters to read each parsed component 3002 and identify its software language. This identification 3004 is also stored in the common construct database 30. For each language class, additional language-dependant parsers 208 are applied to the components to produce object headers for each component and for all component-to-component relationships. Line parsers identify and isolate each line of processing code within each component, extracting information about specific processing within each component. Thread parsers track and extract additional information and relationships which are specific to the software type or original software environment. Thus, language dependent parsers 208 parse the component contents down to their most basic level, identifying object headers, object definitions, function definitions, storage definitions, processing methods, structures, field usage and all other programmatic constructs. The results of this parsing are stored in common database tables the common construct database 30.

Another method of deconstruction is disclosed in U.S. Pat. No. 5,432,942 issued to Trainer, which is incorporated herein in its entirety by reference.

At this stage, the common construct database 30 contains, in a common database format, all types of original software environment components in various states of deconstruction. Standard and custom queries to the common construct database 30 are used to provide and record full details of each program at any level of deconstruction. For example, program, file and database analysis 210 and cross reference interrogation 212 is performed at all deconstruction levels using both pre-defined and custom queries to the common construct database 30. This interrogation provides full insight into data utilization and processing across all software in the common construct database 30. Every component 3000 dependency, whether required at compilation or at execution time, is determined and stored in the common construct database 30 in a common format. The interrogation process creates program-to-program and component-to-component data structures within the common construct database 30 to provide a mechanism to view the flow of any program, application, stream/script, or set of streams/scripts.

From the deconstructed elements 3000 of the original software 100, stored in the common construct database 30, the target software 500 is created. Because the common construct database 30 contains not only all of the most basic elements 3000 of the software, but also the interdependencies and interrelationships of the basic elements, new software can be built which retains the business logic of the original software 100 but which is not limited to simply a one-to-one translation of the original software 100. Information about the target environment 50, the target processing plans, the target languages and configuration is input by the user using a target environment workbench 402 (part of the constructor module 40) into a common database structure 304 in the common construct database 30.

A constructor module 40 writes the target software 500 using the relationships of the basic elements 3000 stored in the common construct database 30. Additionally, language rules and parameters fully define the processing requirements for the new languages and database structures. These rules, parameters and definitions are stored in a common database structure 306 in the common construct database 30 and are applied before any adjustments for a specific implementation are applied. The constructor module 40 has various mechanisms by which a user may input information which is used to tailor how the constructor assembles the elements 3000 to arrive at the target software. For example, renaming workbenches 404 provide a complete common mechanism for simply naming and renaming all components that will be generated for the target environment 50. The naming and renaming details are stored either as fixed values or rules 308 in the common construct database 30. The Definition workbenches 406 allow adjustments to be defined for components and definitions, and the Cross-Mapping workbenches 408 define adjustments that may be required to allow relationship definitions between components in the original and the target environment to be generated. These adjustments are stored as definition rules 310 and cross-mapping rules 312 in the common construct database 30.

In order to construct the new software based upon all of the information in the common construct database 30, the constructor module 40 uses templates 314 to define the structure of all programs, control blocks, subroutines, common areas, controllers, management routines, and any other component types required for compilation and execution of any new component in any target language. These templates 314 may be developed or edited by the user in a templates workbench 410 and are stored in the common construct database 30 as patterns or models that define the general structure for a specific target language. The templates 314 incorporate a unique template language that is understood by the constructor and which includes overall component structures, inline parameter references and settings, common construct database variable references from many of the common construct database tables, and functions that construct blocks of code based upon the common construct database 30 contents. In other words, the templates incorporate a high-level algorithmic language.

The core constructs database 316 contains additional routines, programs and other components that are common to each target software environment. These components are created and stored as core constructs and are re-used and re-delivered for each implementation based upon the original and the new software environment parameters. Shared subroutines provide mechanisms for replacement of original functionality in the target environment. These subroutines are developed and stored based upon the original and target languages and rules. Shared drivers provide runtime routines for flow of control, database traversal and other special processes that are required in each target environment. Shared controls are control blocks, descriptors and other common elements and functions that are required in the target environment. Shared parameters provide inputs into utilities, routines, streams, scripts and other executables in the target environment. Delivery of the shared drivers, controls and parameters is based upon the original and the target configurations.

After the user has input whatever adjustments are necessary, the common construct database 30 now contains information regarding the original software environment 302 (including original software, definitions, information on the original environment, the original processing mechanism, and the original configuration), all information for the target environment 304 (including definitions, target processing plans, target languages and configuration), all original software components 3002 broken down through the increasing levels. of deconstruction to the most basic elements 3000 in a common database structure, all definitions for target languages 306, all adjustments and other implementation-specific definitions 308, 310, 312, all templates 314 to define the structure of the target software, and all core constructs 316. In other words, the common construct database now contains all information required to write the new software for the new target environment.

The constructor module 40 contains a constructor software engine 412 which accesses from the common construct database 30 all of the information required to write the new target software. The constructor engine 412 understands the template language and the parameters and the definitions for both the original and the target environments. Based on the templates, the engine 412 writes the target software code, using core constructs 316, associations between base elements 3000, and the various rules and parameters 306, 308, 310, 312. All new implementation components, including programs, descriptions, environment definitions, control blocks, compilation streams, instruction sets and all other target environment entities are written to the target software database 318.

The constructor 40 also creates the job streams and scripts 414 required for compilation, implementation and delivery of the new software 500 for the target environment 50. The delivery scripts 414 generate software reports 502 which list and define the components delivered and the configuration of the target software 500 in the new environment 50. The software utility inputs 504 are control file inputs or other descriptors that are used by other utilities in the target environment to setup environmental parameters, to compile programs, to generate executables, and to create and/or process all other component types in the new target environment 50. The software descriptions 506 are reports, text documents, control files and other data that are extracted from the target software database 318 and target environment descriptors 304 to further define and document the new environment and its components. Repository extracts 508 are selected unloaded component types from the common construct database 30 and in particular from the target software database 318. Repository extract components include shared copybooks, shared utility streams, special subroutines, or other component types that are loaded directly to the target environment for processing at compilation or execution time. The new software programs 510 are delivered from the target software database for compilation or generation in the new environment.

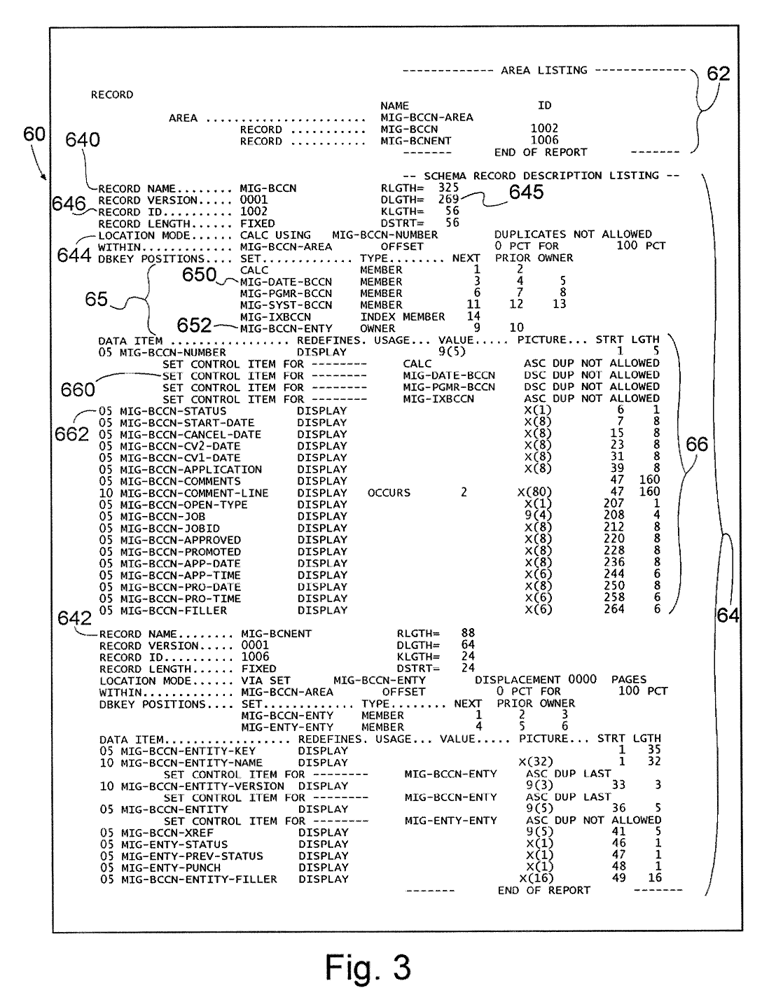

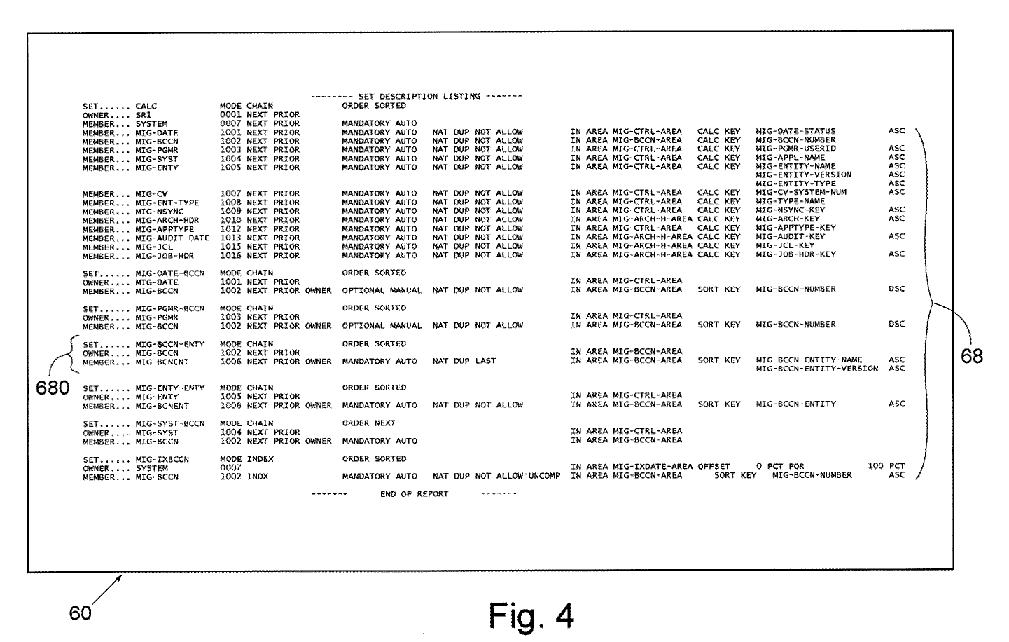

Referring now to FIGS. 3 and 4, the deconstruction process for the original software 100 is reviewed with reference to a specific example—an IDMS to DB2 conversion. FIGS. 3 and 4 illustrate portions of an IDMS database schema report. A schema report is one type of an original software report 102 which comprises the original software 100. FIG. 3 shows excerpts from an area listing 62 and a record description listing 64, and FIG. 4 shows an excerpt from a set description listing 68. These listings, along with program listings, are generally combined into one text file 60. Although in this example an IDMS schema report is used as the original source code, any source for which language-dependent parsers 208 have been developed may be similarly deconstructed, i.e. be resolved into basic constituent elements.

The initial parser 204 and language determination parser 206 within the deconstruction module 20 read the source file 60 and compare the text with known vocabulary and structure to determine that file 60 is an IDMS schema report. IDMS specific parsers then resolve the text into basic elements which are stored in the common construct database 30. Each element within the source file 60 is read and analyzed, including analyzing its position relative to other elements (which is indicative of the element's interrelationships with the other elements). The results of the analysis of each element may be stored in one or more database tables.

The common construct database 30 may include numerous tables to store the extracted components and definitions. For example, administration tables handle the building of proposals, documents, instruction sets and project plans; all information regarding the project, project teams and general project management information is stored in administration tables in the common construct database 30. The common construct tables that define the source and target environments are stored in environment definitions tables. The processing control tables in the common construct database 30 store control parameters. The component identification, inventory and assessment portion of the language and database conversion process uses component identification tables that contain the original source code at different levels of resolution. Database conversion tables store the details of the processing requirements to convert the database definitions and to extract the original data from the databases. Language conversion tables contain the original source code and the source code in various levels of deconstruction; these tables may be specific to the incoming data types. Rules tables store conversion rules, which are predefined for the conversion process. Some rules are standard across all software and/or databases of a specific origin. Other rules are very specific to the desired target. The rules defined for a specific conversion cause the constructors to generate different outputs based upon the current rules for the project. Lastly, security tables may be used to control access to the conversion system and to the individual conversion projects that are in progress.

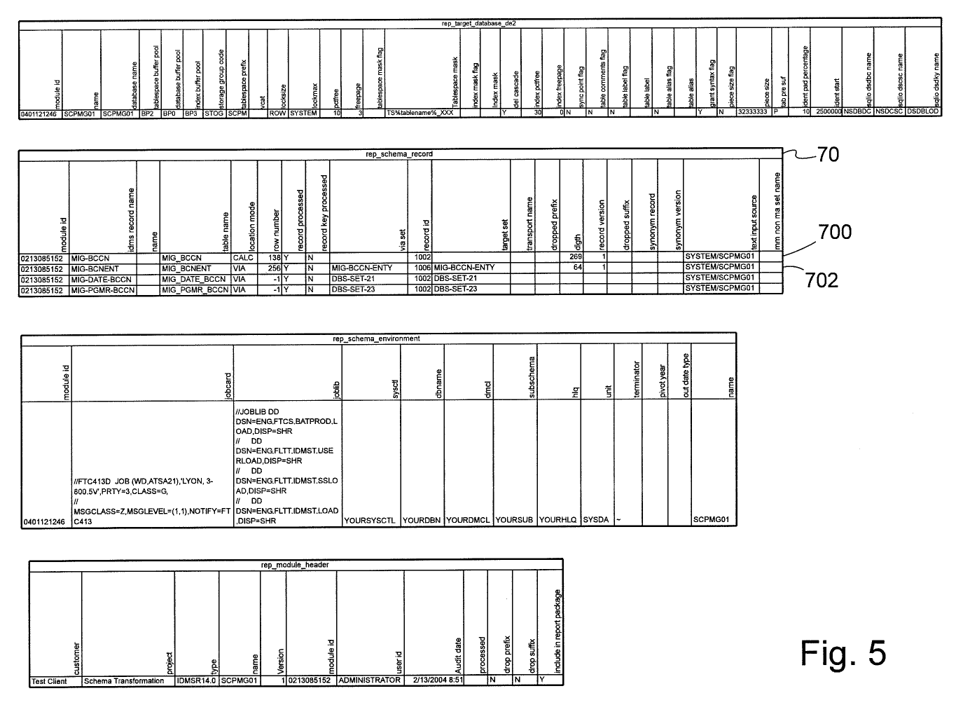

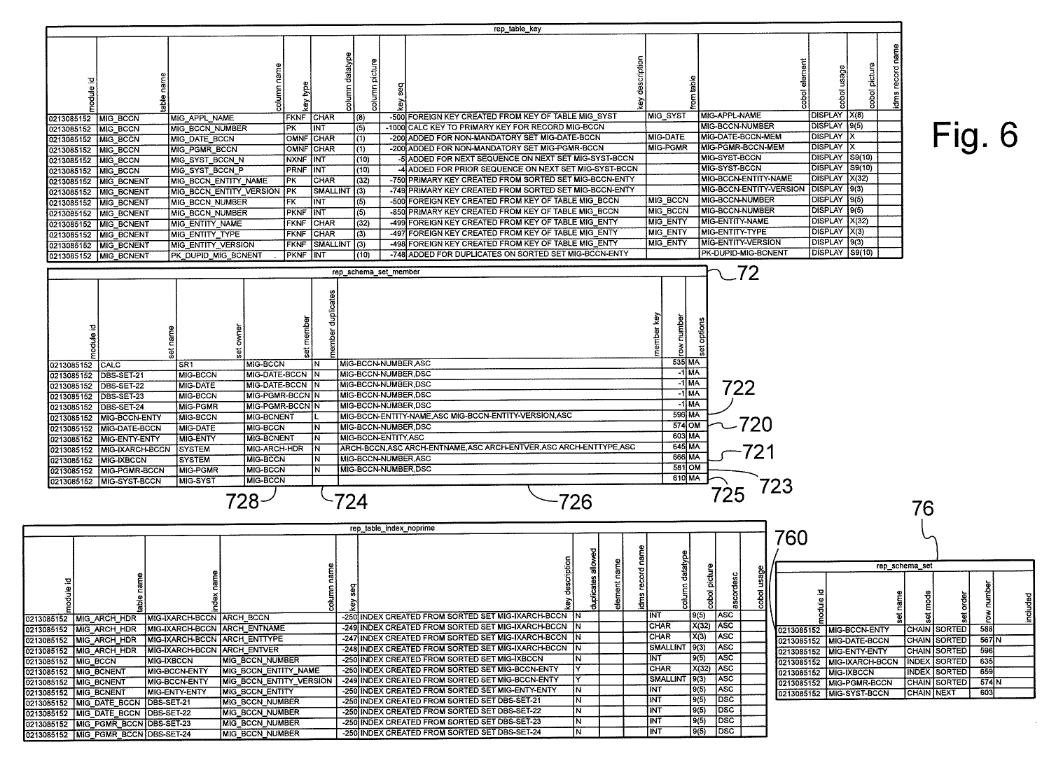

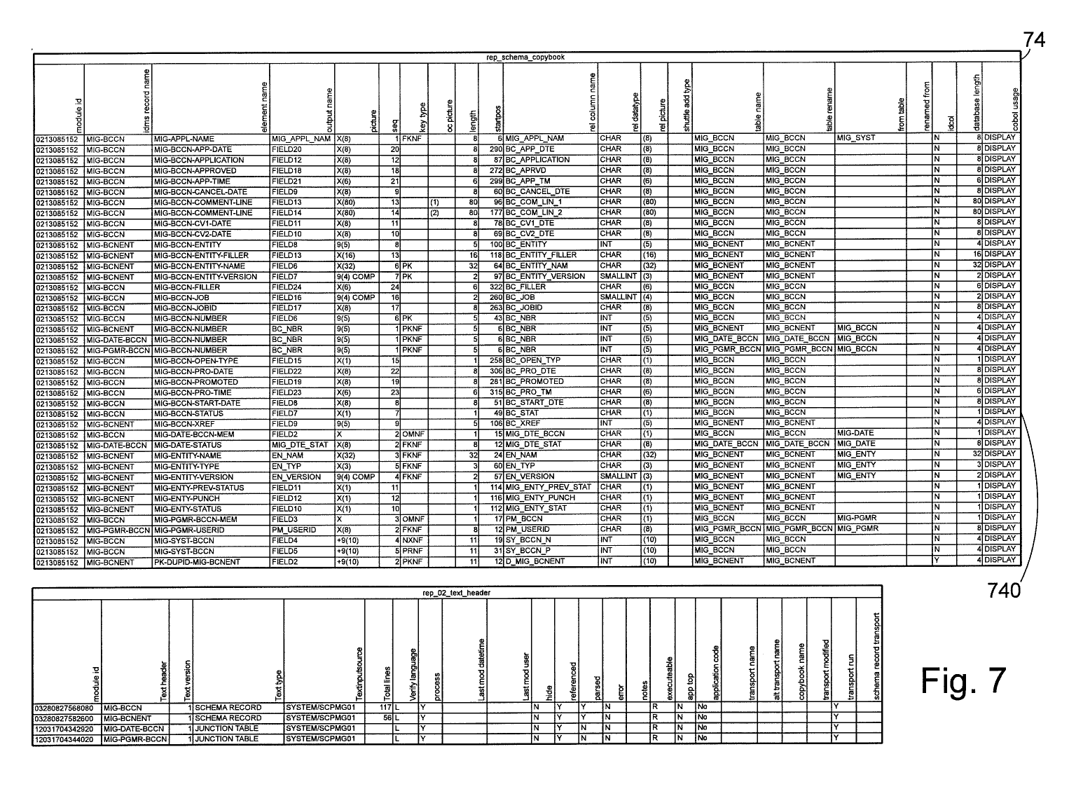

By way of example, the deconstruction process is now illustrated. Referring to FIG. 3, the record description listing 64 includes two records, MIG-BCCN 640 and MIG-BCNENT 642. Code line 644 annotates that the MIG-BCCN record has a location mode of CALC. This information, along with the DLGTH 645 and RECORD ID 646 fields is then stored in the rep_schema_record table 70, line 700 (FIG. 5) in the common construct database 30. The DBKEY POSITIONS text lines 65 indicate that the MIG-BCCN record 640 is a member of the MIG-DATE-BCCN set 650 and an owner of the MIG-BCCN-ENTY set 652, which is interpreted by the deconstruction module 20 and stored in the rep_schema_set_member table 72 lines 720 and 722, respectively (FIG. 6). The record description listing 64 also indicates that the MIG-BCCN record 640 contains a number of data items 66. Line 660 is a set control item for the MIG-DATE-BCCN set 650, belonging to data item MIG-BCCN-NUMBER, and it indicates that the set 650 sorts in descending order (DSC) and that duplicate members are not allowed. The deconstructor 20 stores the information in line 660 in table 72, line 720, columns 724 and 726. The MIG-BCCN-STATUS data item 662 pertains to the computer display, and it is stored in the rep_schema_copybook table 74 line 740 (FIG. 7).

Similarly, FIG. 4 is a set description listing 68 of schema report 60. The MIG-BCCN-ENTY set code lines 680 indicate that the set is MODE CHAIN and ORDER SORTED. This data is extracted by the deconstructor 20 and is stored in the rep_schema_set table 76 line 760 (FIG. 6). Lines 680 also indicate that the set owner of the MIG-BCCN-ENTY set is MIG-BCCN, that the set contains one member, MIG-BCNENT. Further, member MIG-BCNENT is set for DUP LAST and for MANDATORY AUTO sorting on sort keys MIG-BCCN-ENTITY-NAME in ascending order and MIG-BCCN-ENTITY-VERSION in accending order. This information is stored in table 72 line 722 (FIG. 6). All of the source code elements are resolved into base constituent elements 3000 in a manner similar to that described herein and are recorded in the various common construct database tables.

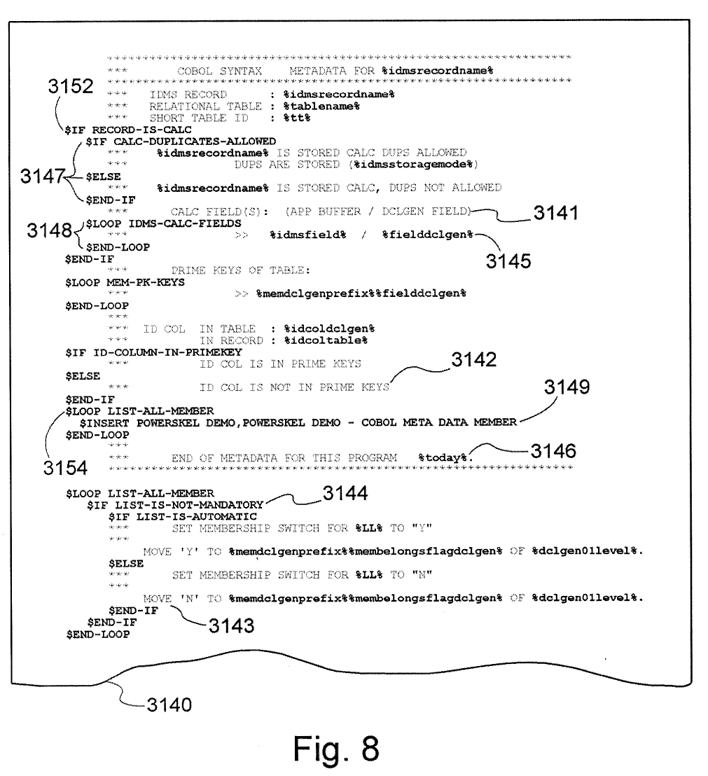

Turning now to a description of the template language according to the invention, FIG. 8 illustrates a portion of a printout of a sample template 3140 for use in constructing COBOL source code. For the purpose of illustration, it can be assumed that the original source code which has been deconstructed originated from an IDMS database schema report, although the templates, which are dependent only on the target environment 50, can be used with any source language which has been resolved into the base components 3000. In other words, once the database definition is resolved from the original software 100 and stored in the common construct database, the source of the definition is no longer relevant. The template according to FIG. 8 is written for a DB2 target environment.

The sample template 3140 of FIG. 8 is composed of template text 3142, shown in. lighter print, and template language elements 3144, shown in bold print and preceded by the ‘$’. The template text 3142, is written in the language of the target environment, in this example, COBOL. For example, lines beginning with asterisks (***) are comment lines 3141, and “MOVE” 3143 is a COBOL function. During the construction process, the template text 3142 is copied by the constructor to the target.

The template language 3144, shown in bold print and beginning with the ‘$’ symbol, include expressions which are evaluated by the constructor 40 during the construction process. The language expressions include variables 3145, conditional statements 3147, iterative control statements 3148, and subroutine statements 3149, among others.

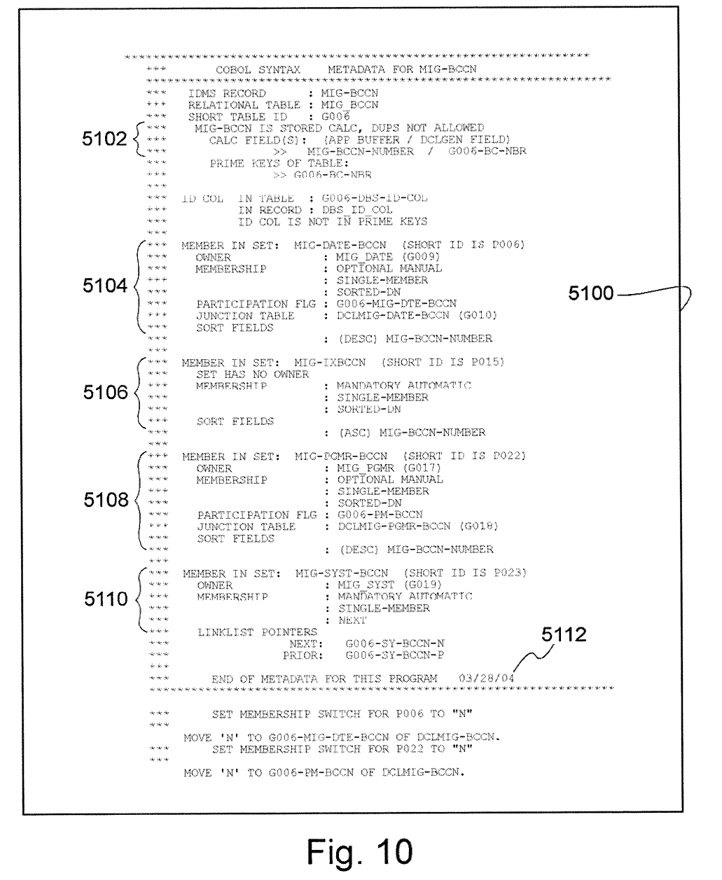

Template language variables 3145 are identified by enclosing percentile syntax and are replaced by the values they represent rather than being literally copied, during software construction. For example, suppose the date the software is generated is Mar. 28, 2004, and the variable %today% 3146 contains the current date. During construction, the template variable %today% 3146 is replaced with “03/28/04” 5112 (FIG. 10).

The template language according to the invention allows for conditional statement processing. Similar to most high-level computer languages, the conditional statements include the $IF, $ELSE and $END-IF constructs 3147, which can be used to form a two-way branch in program flow. If the $IF condition is true, processing continues until the corresponding $ELSE construct is reached; the constructor 40 then jumps directly to the corresponding $END-IF construct and continues from there. On the other hand, if the $IF condition is false, the constructor 40 immediately proceeds to the corresponding $ELSE construct and continues from there.

The template language includes a loop statement 3148 for simplified iterative program flow control. The loop statement 3148 includes the $LOOP and $END-LOOP constructs. When the constructor 40 reaches the $LOOP statement, if the looping condition is true, the statements contained between the $LOOP and $END-LOOP markers are evaluated, and program flow returns to the $LOOP statement and the process repeats. When the looping condition is false, the constructor jumps to the $END-LOOP marker to continue processing.

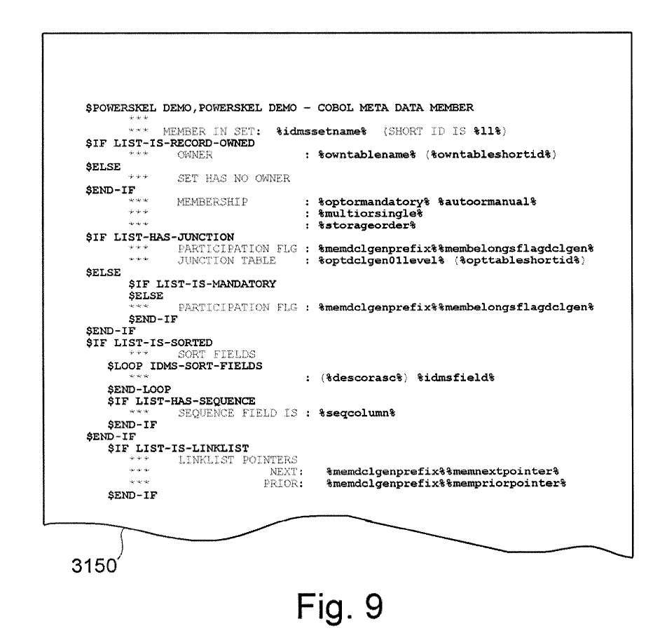

FIGS. 8 and 9 collectively illustrate the subroutine function of the template language. FIG. 8 contains an $INSERT statement 3149, which calls a function of subroutine titled “$POWERSKEL DEMO,POWERSKEL DEMO—COBOL META DATA MEMBER.” FIG. 9 illustrates a subroutine 3150, written in the template language according to the invention, which is called by the insert statement 3149 of FIG. 8. When the constructor 40 reaches an $INSERT statement, processing jumps to the subroutine by the called name and continues there until it reaches the end of the subroutine code, after which the constructor returns to the statement following the $INSERT call.

Although not illustrated, the template language according to the invention also includes a set statement. $SET is a directive to the constructor 40 that allows a variable name to be set to a value and then to be referenced within the generated code as the variable name. The resulting code will reflect the value to which the variable was set. For example,

$SET LEVEL=01 PERFORM PROCESS−%LEVEL%

is converted to “PERFORM PROCESS-01.”

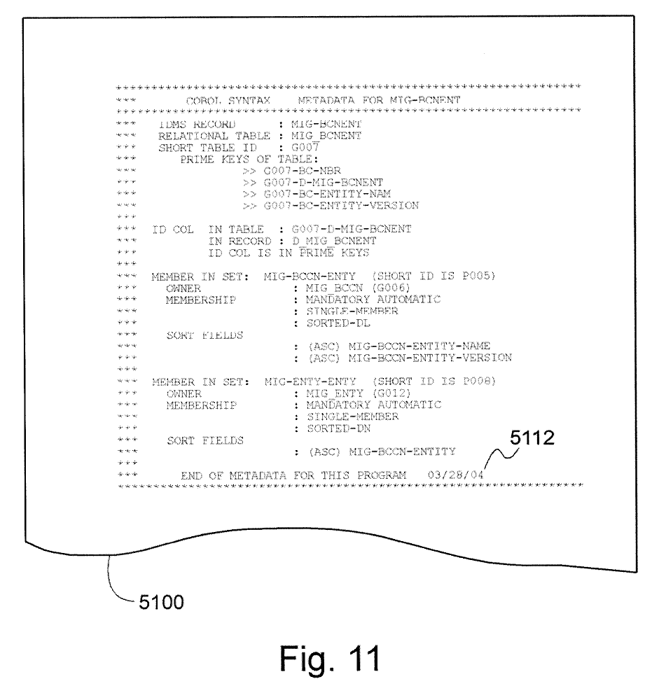

FIGS. 10 and 11 illustrate the output 5100 source code of constructor 40 based on the templates of FIG. 8 and 9 using data contained in the tables of FIGS. 5-7 resolved from the source code listing of FIGS. 3 and 4. FIG. 10 shows the output for the MIG-BCCN record 640 (FIG. 3) and FIG. 11 shows the output for the MIG-BCNENT record 642 (FIG. 3).

Referring to FIG. 10, code lines 5102 appear because of the $IF-RECORD-IS-CALC statement 3152 (FIG. 8); rep_schema_record table 70 (FIG. 5) line 700 shows that MIG-BCCN record has a CALC location mode. Note that in FIG. 11, there in no corresponding lines of code, since for the MIG-BCNENT record, table 70 line 702, the location mode is VIA and not CALC.

In FIG. 8, the $INSERT statement 3149 for the meta data member subroutine 3150 of FIG. 9 is contained in a loop statement 3154 for all members of the record. Column 728 of the rep_schema_set_member table 72 (FIG. 6) shows that MIG-BCCN is a member of the MIG-DATE-BCCN 720, MIG-IXBCCN 721, MIG-PGMR-BCCN 723, and MIG-SYST-BCCN 725 sets. Thus, these sets and their associated data are pulled from the common construct database 30 during the construction process and included in the output 5100 of FIG. 10, 5104, 5106, 5108, and 5110, respectively. The output of FIG. 11 is similarly generated by the constructor 40.

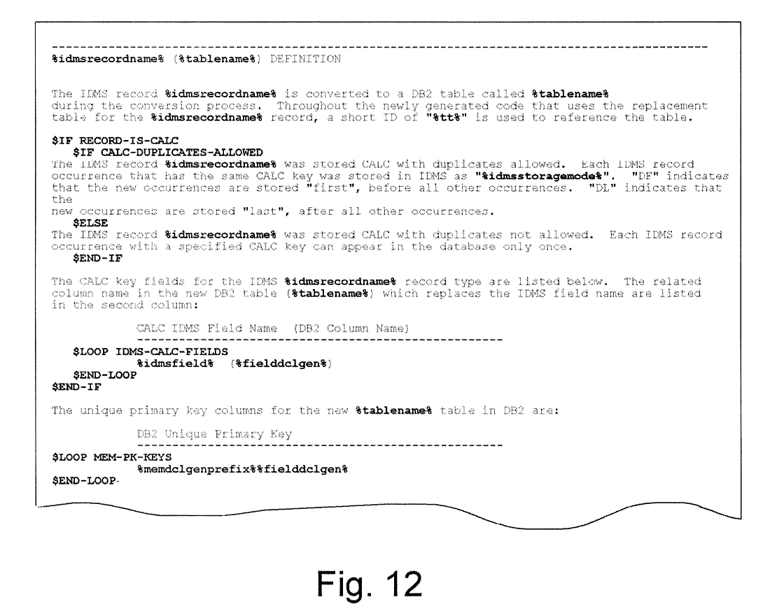

FIG. 12 shows a portion of a template 80 using the template language of the invention. The template is written for the English language and may be used to generate documentation along with generated computer source code.

While the preferred embodiment of the invention have been illustrated in detail, it is apparent that modifications and adaptations of the preferred embodiment will occur to those skilled in the art. Such modifications and adaptations are in the spirit and scope of the invention as set forth in the following claims:

What is claimed is:

1. A method for converting a source legacy database system (10) to a target relational database system (40), the source legacy database system defining an environment that includes a first non-source-code database definition file and a first computer program source code file (110), the method comprising the steps of:
collecting the entirety (302) of said source legacy database system;
storing said entirety in a relational common construct database (30);
resolving said first non-source-code database definition file and said first computer program source code file into a plurality of basic constituent elements (3000) thereof;
storing said plurality of basic constituent elements in said relational common construct database;
writing at least one template (314) in an algorithmic language;
storing said at least one template in said relational common construct database; and
writing said target relational database from said at least one template as a function of said plurality of basic constituent elements, said at least one template controlling said writing.

2. The method of claim 1 further comprising the steps of:
writing a condition statement (3147) in said at least one template, said condition statement having a condition expression contained therein,
evaluating said condition expression,
performing a first task if said condition expression is evaluated to be a first value, and
performing a second task if said condition expression is evaluated to be a second value.

3. The method of claim 1 further comprising the steps of:
writing an iteration statement (3148) in said at least one template, said iteration statement having an iteration expression contained therein,
iteratively evaluating said iteration expression, and
performing a task while said iteration expression is evaluated to be a particular value.

4. The method of claim 1 further comprising the steps of:
writing a subroutine statement (3149) in said at least one template, said subroutine statement having a subroutine name contained therein,
designating a portion of said at least one template by said subroutine name, and
interpreting said subroutine statement as a directive to control said writing by said portion.

5. The method of claim 1 further comprising the steps of:
writing a set statement in said at least one template, said set statement having a set expression and a set variable contained therein,
assigning said set expression to said set variable.

6. A system for converting a source database system (302) to a target database system (318), said source database system composed of a plurality of basic constituents (3000) that are arranged to form at least a first non-source-code database definition file and a first computer program source code file (110), said target database having substantially equivalent functionality as said source database, the system comprising:
at least one computer system;
a relational database management system structured for execution by said at least one computer system;
a deconstruction program (20) structured for execution by said at least one computer system;
a construction program (40) structured for execution by said at least one computer system;
a relational common construct database (30) operably coupled by said relational database management system to said deconstruction program and said construction program;
said source database system stored in said relational common construct database;
said deconstruction program operatively coupled to said source database system for resolving said first non-source-code database definition file and said computer program source code file into said plurality of basic constituents;
each of said plurality of basic constituents individually stored in said relational common construct database;
a template (314) written in an algorithmic language stored in said relational common construct database and operatively coupled to said construction program for controlling said construction program in writing said target database system as a function of said plurality of basic constituents,
said construction program operatively coupled to said target database system; and
said target database system stored in said relational common construct database.

7. The system of claim 6 wherein:
said deconstruction program includes a language-determination parser (206); and
said deconstruction program includes at least one language-dependent parser (208).

8. The system of claim 6 further comprising:
an environment description of said source database system stored in said relational common construct database; and
a target environment description stored in said relational common construct database.

9. The system of claim 6 wherein:
said construction program includes a template workbench (410) designed and arranged for editing said template;
said algorithmic language includes a statement selected from the group consisting of a condition statement (3147) having a condition expression contained therein, an iteration statement (3148) having an iteration expression contained therein, a subroutine statement (3149) having a subroutine name contained therein, and a set statement having a set expression and a set variable contained therein;
said construction program being designed and arranged to interpret said condition statement as a directive to evaluate said condition expression and perform a first task if said condition expression is evaluated to be a first value and perform a second task if said condition expression is evaluated to be a second value;
said construction program being designed and arranged to interpret said iteration statement as a directive to iteratively evaluate said iteration expression and perform a task while said iteration expression is evaluated to be a particular value;
said template (314) having a portion therein designated by said subroutine name, said construction program being designed and arranged to interpret said subroutine statement as a directive to interpret said portion, wherein when said construction program has completed interpreting said portion, said construction program interprets said algorithmic language immediately following said subroutine statement; and
said construction program being designed and arranged to interpret said set statement as a directive to assign said set expression to said set variable.

10. The system of claim 6 wherein:
said source database system is a legacy database system;
said target database system is a relational database system;
said template generally defines the structure of a target computer program source code file of said target database system; and
said construction program is arranged and designed to interpret said template and write said target computer program source code file therefrom.

11. The system of claim 9 wherein,
said algorithmic language includes a condition evaluation means to control said writing in a first manner if said condition expression is evaluated to be a first value and control said writing in a second manner if said condition expression is evaluated to be a second value.

12. The system of claim 9 wherein,
said algorithmic language includes a looping means to iteratively evaluate a looping expression and iteratively control said writing in a predetermined manner while said iteration expression is evaluated to be a particular value.

13. The system of claim 9 wherein,
said algorithmic language includes a means to include subroutines.

14. The system of claim 9 wherein,
said template language includes a means to assign a variable a predetermined value.

15. A system for converting a source database system (302) to a target database system (318), said source database system defining an environment that includes a first non-source-code database definition file and a first software program source code file (110), the system comprising:
at least one computer system having a relational database management system and a common construct database (30);
said first non-source code database definition file and said first software program source code file stored in said common construct database by said relational database management system of said at least one computer system;
a conversion software program resident on said at least one computer system designed and arranged to receive as an input said first non-source-code database definition file and said first software program source code file and to produce as an output said target database system;
said common construct database including a template written in an algorithmic language that controls said conversion software program and defines the structure of said target database system.

16. The system of claim 15 wherein
said first non-source-code database definition file is structured as a software report (102).

17. The system of claim 15 wherein
said first non-source-code database definition file is structured as a utility (104).

18. The system of claim 15 wherein
said first non-source-code database definition file is structured as a descriptor (106).

19. The system of claim 15 wherein
said first non-source-code database definition file is structured as a repository extract (108).

20. The system of claim 15 wherein:
said source database system is a legacy database system; and
said target database system is a relational database system.
